(19) United States
(12) Patent Application Publication
(10) Pub. No.: US 2007/0037721 A1
(43) Pub. Date: Feb. 15, 2007

(54) Moistened disposable wipe for controlling allergens

(75) Inventors: Alice Jean Michels, Cincinnati, OH (US); Jamesina Anne Fitzgerald, Trenton, OH (US); Daniel Charles Peck, Mason, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/513,718

(22) Filed: Aug. 31, 2006

Related U.S. Application Data
(63) Continuation-in-part of application No. 11/216,836, filed on Aug. 31, 2005.
(63) Continuation-in-part of application No. 11/443,836, filed on May 31, 2006.
(60) Provisional application No. 60/731,718, filed on Oct. 31, 2005.
(60) Provisional application No. 60/606,820, filed on Sep. 1, 2004.
(60) Provisional application No. 60/685,815, filed on May 31, 2005.

(51) Int. Cl. C11D 17/00

(52) U.S. Cl. 510/295

(57) ABSTRACT

Wipes for use in and around the house. The present invention relates to disposable wipes for household use which help reduce and control allergens. The wipes include an allergen control agent. The wipes may be moistened. The wipes may be used to treat surfaces such as fabric-based surfaces in and around the house. The present invention also relates to a method for treating surfaces in and around the house utilizing the disposable wipes of the present invention.

### CROSS REFERENCE TO RELATED APPLICATIONS

This application claims the benefit of U.S. Provisional Application Ser. No. 60/731,718 filed Oct. 31, 2005 and is a continuation-in-part of:

U.S. application Ser. No. 11/216,836 filed Aug. 31, 2005 which claims the benefit of U.S. Provisional Application Ser. No. 60/606,820 filed Sep. 1, 2004; and

U.S. application Ser. No. 11/443,836 filed May 31, 2006 which claims the benefit of U.S. Provisional Application Ser. No. 60/685,815 filed May 31, 2005.

### FIELD

The present invention relates to moistened disposable wipes for household and automotive use for the control of indoor allergens. The present invention also relates to a method for cleaning and reducing allergens from fabric-based materials around the home and automobile utilizing the moistened wipes of the present invention.

### BACKGROUND

House dust is comprised of many components. While its content can vary considerably, a speck of dust can contain fabric fibers, human skin particles, animal dander, house dust mites, parts of cockroaches, mold spores, bacteria, food particles, and other debris. For numerous individuals, many of these dust components are allergenic, including the most common culprits, dust mites, pet dander, and mold spores. One dust particle may contain an agglomeration of these various components. These components are often associated with the onset of a runny or stuffy nose, itchy/watery/red eyes, and sneezing for allergy sufferers. Unfortunately, house dust is present even in “clean” homes. Some of the common reservoirs of indoor allergens include the fabrics of bedding, upholstery, drapery, and carpets.

Laundering is one approach to combat dust allergens. Yet, for many home fabrics, such as upholstery and draperies, washing or dry-cleaning are not easy or readily available options. As a result, consumers will often report that they clean these articles routinely by vacuuming. Yet, in actuality, “routinely” translates into vacuuming the upholstery and draperies once or twice yearly, or cleaning the fabric surfaces with a dust cloth or old T-shirt a couple of times monthly. Unarguably, vacuuming and dusting may reduce the level of dust in home fabrics; however, it is believed that there are many dust components, including allergens, that are very difficult to remove by these measures (American College of Allergy, Asthma, & Immunology On-Line, Public Education: Indoor Allergy Survival Tips, 2005). In addition, there is a growing concern that these practices may be contributing to the allergen problem. That is, both vacuuming and dusting have been implicated in rendering allergens airborne during the cleaning process, which can make things considerably worse for the allergy sufferer. Consequently, these normal housekeeping practices are neither sufficient nor conducted with the necessary frequency to reduce the level of indoor allergens on home fabrics.

This present invention embodies a moistened disposable wipe uniquely designed to remove allergens from fabric surfaces. The moistened, disposable wipe quickly, easily, and gently removes dirt and contamination from the surfaces of fabrics without fraying and without leaving lint behind. The moistened disposable wipe also removes allergens (typically very small in size, generally ranging from about 0.1 micron to 100 microns) from fabric surfaces so that they can be placed in the garbage and not in the air or home, while at the same time depositing allergen control agents on the fabric surface contacted by the wipe.

This and other features, aspects, advantages, and variations of the present invention will become evident to those skilled in the art from a reading of the present disclosure with the appended claims and are covered within the scope of the claims.

### SUMMARY

The present invention relates to a moistened disposable wipe for cleaning household fabric-based materials. The wipe comprises a substrate and a composition. The composition comprises:

i) from about 0.01% to about 25% by weight of an allergen control agent;

ii) from about 0.05% to about 15% by weight of an organic solvent; and

iii) balance water and optional components.

The present invention also relates to a method for cleaning household surfaces. The method comprises the steps of:

a) providing a disposable wipe wherein the disposable wipe comprises:

a substrate which is comprised of at least one ply which includes a composition applied to the substrate wherein the composition is applied to the substrate in the amount of from about 0.5 grams of the composition/gram of the substrate by weight to about 8 grams of the composition/gram of the substrate by weight. The composition comprises:
i) from about 0.01% to about 25% by weight of an allergen control agent;
ii) from about 0.05% to about 15% by weight of an organic solvent; and
iii) balance water and other optional components;

b) contacting the surface to be cleaned with the disposable wipe;

c) applying the composition to the surface; and

d) transferring dirt and contaminants from the surface to the disposable wipe.

The present invention additionally relates to a kit for cleaning household surfaces. The kit comprises:

a) a moistened disposable wipe comprising a substrate which is comprised of at least one ply which includes a composition applied to the substrate wherein the composition is applied to the substrate in the amount of from about 0.5 grams of the composition/gram of the substrate by weight to about 8 grams of the composition/gram of the substrate by weight. The composition comprises:

i) from about 0.01% to about 25% by weight of an allergen control agent;

ii) from about 0.0.01% to about 15% by weight of an organic solvent;

iii) balance water; and

b) an implement to which the moistened disposable wipe is attached for facilitating contact of the moistened disposable wipe to the household surface.

### BRIEF DESCRIPTION OF THE DRAWINGS

FIG. 1 is a perspective view of one embodiment of a moistened wipe substrate made in accordance with the present invention.

FIG. 2 is a cross-sectional view of a portion of the wipe substrate of FIG. 1.

FIG. 3 is a magnified detail view of one bond site of a laminate substrate made in accordance with the present invention.

FIG. 4 is a top plan view of another embodiment of a substrate made in accordance with the present invention.

FIG. 5 is a cross-sectional view of a portion of the substrate shown in FIG. 4.

### DETAILED DESCRIPTION

Reference will now be made in detail to various embodiments of the present invention, examples of which are illustrated in the accompanying drawings wherein like numerals indicate the same elements throughout the views. All percentages, ratios and proportions herein are on a weight basis unless otherwise indicated.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”.

As used herein, the terms “cleaning sheet”, “moistened disposable wipe”, and “moistened wipe”, “disposable wipe” and “wipe” may be used interchangeably herein.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein. As used herein the term “fabric” encompasses articles of fabric including but not limited to: clothing, upholstery, linen, draperies, clothing accessories, leather, floor coverings, and the like. The term also encompasses other items made in whole or in part of fabric, including but not limited to tote bags, furniture covers, leather upholstery and other leather products, automobile interiors, tarpaulins, shoes, window screens, stuffed animals, pillows, mattresses, and the like.

As used herein, the term “moistened” refers to the addition of a liquid to the substrate either prior to or at the time of use. The term “liquid” includes any material having a liquid phase, including but not limited to emulsions having a liquid phase. The substrate may be moistened with liquid during manufacture or it may be moistened with liquid after manufacture (e.g.; by the user at point of use).

As used herein, the term “disposable” is used to describe articles which are not intended to be laundered or otherwise restored but rather are intended to be discarded after use.

As used herein, the term “nonwoven” refers to a substrate that has a structure of individual fibers or threads which are interlaid, but not in any regular or repeating manner. Nonwoven substrates may be formed by a variety of processes including but not limited to meltblowing processes, spunbonding processes, and bonded carded processes. As used herein, the term “microfibers”, refers to small diameter fibers having an average diameter not greater than about 100 microns.

As used herein, the term “meltblown fibers”, refers to fibers formed by extruding a molten thermoplastic material through a plurality of fine, usually circular, die capillaries as molten threads or filaments into a high velocity gas (e.g., air) stream which attenuates the filaments of molten thermoplastic material to reduce their diameter, which may be to a microfiber diameter. Thereafter, the meltblown fibers are carried by the high velocity gas stream and are deposited on a collecting surface to form a web of randomly dispersed meltblown fibers.

As used herein, the term “spunbonded fibers”, refers to small diameter fibers which are formed by extruding a molten thermoplastic material as filaments from a plurality of fine, usually circular, capillaries of a spinneret with the diameter of the extruded filaments then being rapidly reduced by drawing.

As used herein, “laminate” and “composite” are used interchangeably to describe substrates which may be used with the present invention. Both refer to a substrate formed from at least two webs joined in a face to face relationship to form a unitary web comprised of more than one ply or layer.

As used herein, the term “polymer” generally includes, but is not limited to, homopolymers, copolymers, such as, for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiaotactic and random symmetries.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Moistened Disposable Wipe

The moistened disposable wipe of the present invention comprises a substrate and a composition which is applied thereto wherein the composition is applied to the substrate in the amount of from about 0.5 grams of the composition/gram of the substrate by weight to about 8 grams of the composition/gram of the substrate by weight.

A. Substrate

The substrate of the present invention may be any suitable wipe substrate including but not limited to baby wipes, cleaning wipes, towelettes, and the like. The substrate of the present invention may be made in accordance with (but not limited to): PCT Publication No. WO 2004/080265 published in the name of Hofte et al. on Sep. 23, 2004; U.S. Publication No. 2006/0052269 published in the name of Panandiker et al. on Mar. 9, 2006; U.S. Pat. No. 6,716,805 issued to Sherry et al. on Apr. 6, 2004, U.S. Pat. No. 6,561,354 issued to Fereshtehkhou et al. on May 13, 2003; U.S. Publication No. 2003/0028165 published in the name of Curro et al. on Feb. 6, 2003 and U.S. Publication No. 2002/0034912 published in the name of Curro et al. on Mar. 21, 2002. The substrate of the present invention may be comprised of one or more plies. The substrate may comprise woven and/or nonwoven, unmodified and/or modified natural fibers (one non-limiting example of which is a cellulosic-based fiber such as wood pulp fiber), synthetic fibers, or mixtures thereof.

Other natural fibers which may be used include but are not limited to cotton, Esparto grass, bagasse, hemp, flax, silk, wool, wood pulp, chemically modified wood pulp, jute, ethyl cellulose, and/or cellulose acetate. Suitable synthetic fibers include but are not limited to polyvinyl chloride, polyvinyl fluoride, polytetrafluoroethylene, polyvinylidene chloride, polyacrylics such as ORLON®, polyvinyl acetate, rayon, polyethylvinyl acetate, non-soluble or soluble polyvinyl alcohol, polyolefins such as polyethylene (e.g., PULPEX®) and polypropylene, polyamides such as nylon, polyesters such as DACRON® or KODEL®, polyurethanes, polystyrenes, and the like, including fibers comprising polymers containing more than one monomer.

The fibers useful herein can be hydrophilic, hydrophobic, or can be a combination of both hydrophilic and hydrophobic fibers. As indicated above, the particular selection of hydrophilic or hydrophobic fibers depends upon the other materials included in the absorbent (and to some degree) the scrubbing layer described hereinafter. Suitable hydrophilic fibers for use in the present invention include cellulosic fibers, modified cellulosic fibers, rayon, cotton, polyester fibers such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene, polypropylene, polyacrylics, polyamides, polystyrenes, polyurethanes and the like.

Suitable wood pulp fibers include those obtained from well-known chemical pulping processes such as the kraft and sulfite processes. It may be desirable to derive these wood pulp fibers from southern softwoods due to their premium absorbency characteristics. These wood pulp fibers can also be obtained from mechanical pulping processes, such as stone groundwood, refiner mechanical, thermomechanical, chemimechanical, and chemi-thermomechanical pulping processes. Recycled or secondary wood pulp fibers, as well as bleached and unbleached wood pulp fibers, can also be used.

Another type of hydrophilic fiber which may be used in the present invention is chemically stiffened cellulosic fiber. As used herein, the term “chemically stiffened cellulosic fiber” means cellulosic fibers that have been stiffened by chemical means to increase the stiffness of the fibers under both dry and aqueous conditions. Such means can include the addition of a chemical stiffening agent that, for example, coats and/or impregnates the fibers. Such means can also include the stiffening of the fibers by altering the chemical structure, e.g., by crosslinking the polymer chains.

If fibers are used as the absorbent layer (or a constituent component thereof), the fibers can optionally be combined with a thermoplastic material. Upon melting, at least a portion of this thermoplastic material migrates to the intersections of the fibers, typically due to interfiber capillary gradients. These intersections become bond sites for the thermoplastic material. When cooled, the thermoplastic materials at these intersections solidify to form the bond sites that hold the matrix or substrate of fibers together in each of the respective layers. This can be beneficial in providing additional overall integrity to the cleaning wipe.

Various methods can be used to form a suitable substrate for use in the present invention. Suitable methods include but are not limited to spunbonding, meltblowing, carding, wet laying, and airlaying. Suitable techniques for binding the fibers of the substrate together include but are not limited to hydroentangling, needle punching, thermal bonding, ultrasonic bonding, chemical bonding, surface treating, and laminating.

When utilizing a substrate comprised of more than one ply, wherein one of the plies is an absorbent layer, the fibers can optionally be combined with a thermoplastic material. Upon melting, at least a portion of this thermoplastic material migrates to the intersections of the fibers, typically due to interfiber capillary gradients. These intersections become bond sites for the thermoplastic material. When cooled, the thermoplastic materials at these intersections solidify to form the bond sites that hold the matrix or substrate of fibers together in each of the respective plies. This may be beneficial in providing additional overall integrity to the wipe.

Thermoplastic materials useful in the present invention can be in any of a variety of forms including particulates, fibers, or combinations thereof. Suitable thermoplastic materials can be made from any thermoplastic polymer that can be melted at temperatures that will not extensively damage the fibers that comprise the primary substrate or matrix of each ply. Typically, the melting point of this thermoplastic material will be less than about 190° C., and generally between about 50° C. and about 175° C.

Suitable thermoplastic fibers can be made from a single polymer (monocomponent fibers), or can be made from more than one polymer (e.g., bicomponent fibers). Sheath/core bicomponent fibers refers to thermoplastic fibers that comprise a core fiber made from one polymer that is encased within a thermoplastic sheath made from a different polymer. The polymer comprising the sheath often melts at a different, typically lower, temperature than the polymer comprising the core. As a result, these bicomponent fibers provide thermal bonding due to melting of the sheath polymer, while retaining the desirable strength characteristics of the core polymer.

Suitable bicomponent fibers for use in the present invention can include but are not limited to sheath/core fibers having the following polymer combinations: polyethylene/polypropylene, polyethylvinyl acetate/polypropylene, polyethylene/polyester, polypropylene/polyester, copolyester/polyester, and the like. Particularly suitable bicomponent thermoplastic fibers for use herein are those having a polypropylene or polyester core, and a lower melting copolyester, polyethylvinyl acetate or polyethylene sheath (e.g., those available from Danaklon a/s, Chisso Corp., and CELBOND®, available from Hercules). These sheath/core bicomponent fibers can be concentric or eccentric. As used herein, the terms “concentric” and “eccentric” refer to whether the sheath has a thickness that is even, or uneven, through the cross-sectional area of the bicomponent fiber. Eccentric bicomponent fibers may be desirable in providing more compressive strength at lower fiber thicknesses.

Suitable methods for preparing thermally bonded fibrous materials are described in U.S. Pat. No. 5,607,414 issued to Richards et al. on Mar. 4, 1997 and U.S. Pat. No. 5,549,589 issued to Homey et al. on Aug. 27, 1996.

Another method of bonding the fibers is chemical bonding. Common chemical bonding agents include but are not limited to solvent based and resin based adhesives (e.g.; latex, etc.).

The wipe may also be comprised of a HIPE-derived hydrophilic, polymeric foam. Such foams and methods for their preparation are described in U.S. Pat. No. 5,550,167 issued to DesMarais on Aug. 27, 1996.

The substrate of the present invention typically has a basis weight of about 40 g/m² to about 250 g/m² or from about 50 g/m² to about 120 g/m² as measured in accordance with ASTM D3776-96 and a caliper of from about 0.3 mm to about 2 mm. The substrate of the present invention typically has a liquid holding capacity of about 1 gram of liquid/gram of substrate to about 10 grams of liquid/gram of substrate, or about 2 grams of liquid/gram of substrate to about 8 grams of liquid/gram of substrate, or about 3 grams of liquid to about 5 grams of liquid/gram of substrate. The substrate also typically has a fuzz level of less than about 0.8 mg/cm², or less than about 0.5 mg/cm², or less than about 0.3 mg/cm². The substrate typically has a dry cross direction (“CD”) stiffness value of from about 0.01 g-cm to about 2 g-cm and a wet cross direction stiffness value of from about 0.005 g-cm to about 2 g-cm, or from about 0.1 g-cm to about 1.5 g-cm.

In one non-limiting embodiment, the substrate can be an airlaid nonwoven fibrous substrate comprising a combination of natural fibers, staple length synthetic fibers and a latex adhesive binder. The dry fibrous substrate can be about 20% to 80% by weight wood pulp fibers, about 10% to 60% by weight staple length polyester fibers, and about 10% to 25% by weight binder.

In another non-limiting embodiment, the dry fibrous substrate can comprise at least about 50% by weight wood pulp fibers, and more preferably at least about 70% by weight wood pulp fibers. One particular airlaid nonwoven fibrous substrate which is suitable for use in the present invention comprises about 75% by weight Southern softwood Kraft wood pulp fibers having an average fiber length of about 2.6 mm; about 12% by weight polyester fibers having a denier of about 1.35 grams per 9000 meters of fiber length and a staple length of about 0.85 inch; and about 13% by weight of a binder composition comprising a styrene butadiene copolymer. The styrene butadiene copolymer may have a styrene to butadiene ratio of about 45 parts styrene to 55 parts butadiene. A latex adhesive suitable for making the binder composition is ROVENE 5550 (containing about 50 weight percent solids of styrene butadiene copolymer) available from Mallard Creek Polymers of Charlotte, N.C.

In a further non-limiting embodiment the substrate of the present invention is formed by air laying a blend of natural and synthetic fibers to form a fibrous web, spraying water on the web, and then embossing the web. A latex adhesive binder is then applied to the web, followed by drying and curing of the latex adhesive binder in an oven. The nonwoven web may then be moistened with a liquid.

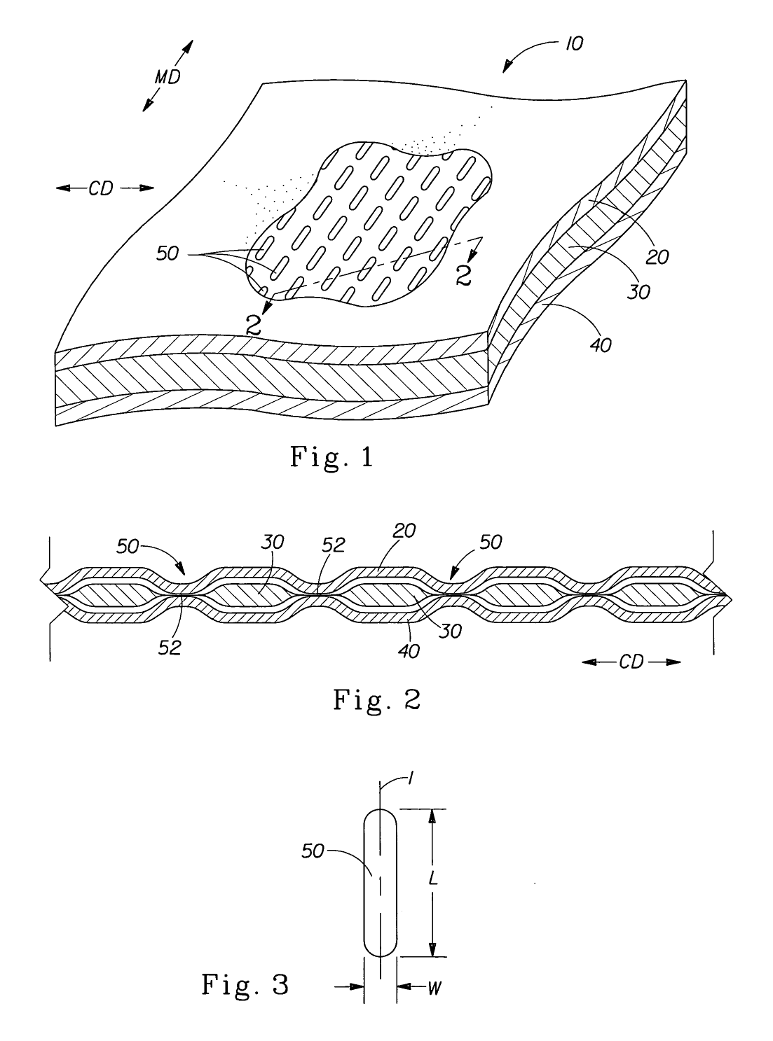

In yet another non-limiting embodiment the substrate is a laminate substrate formed from a laminate web 10 comprising at least three layers or plies, disposed in a layered, face-to-face relationship, as shown in FIG. 1. The layers should be sufficiently thin to be processible such as described in U.S. Publication No. 2003/0028165, but no actual thickness (i.e., caliper) is considered limiting. A first outer layer 20, is typically thermally bondable, and may be a nonwoven web comprising a sufficient quantity of thermoplastic material, the web having a predetermined extensibility and elongation to break. By “sufficient quantity” is meant a quantity of thermoplastic material adequate to enable enough thermal bonding upon application of heat and/or pressure to produce a unitary web. A second outer layer, 40, is typically the same material as first outer layer 20, but may be a different material. Second outer layer, 40 is also generally thermally bondable and has a predetermined extensibility and elongation to break. At least one third central layer 30 may be disposed between the two outer layers. The laminate web 10 is processed by joining means, such as by ultrasonic welding, or thermal calendaring as described in U.S. Publication No. 2003/0028165 to provide a plurality of melt bond sites 50 that serve to couple the outer layers 20 and 40, and, in some embodiments, portions of central layer 30, thereby forming the constituent layers into a unitary web. When joined together, the two outer layers form an interior region between them. The interior region is the space between the outer layers surrounding the bond sites 50. In one non-limiting embodiment, the third central layer 30 substantially fills the interior region, the third central layer 30 being apertured coincident the bond sites 50.

While the laminate web 10 is disclosed primarily in the context of nonwoven webs and composites, in principle the laminate web 10 can be made out of any web materials that meet the requirements, (e.g., melt properties, extensibility) as disclosed herein. For example, the outer layers 20 and 40 can be thermoplastic films, micro-porous films, apertured films, and the like. Central layer 30 can be paper, including tissue paper; metal, including metal foil; other non-thermoplastic web material, woven fabric, and the like. In general, it is required that outer layer materials be flexible enough to be processed as described herein. However, central layer can be a brittle, relatively stiff material, as long at it also can be processed as described herein, albeit possibly becoming fractured, broken, or otherwise broken up in the process.

The laminate substrate may be apertured, non-apertured, or a combination thereof. The laminate substrate may have an average aperture size of from about 0.01 mm² to about 4 mm² or from about 0.5 mm² to about 2.5 mm². The percentage of the laminate which is comprised of apertures may be express as the percent open area. The percent open area of the laminate of the present invention may be from about 2% to about 25% or from about 5% to about 20%. In one non-limiting embodiment as shown in cross-section in FIG. 2, central layer 30 can be apertured, without aperturing the two outer layers to provide a three-layer laminate characterized by the laminate web 10 (as a whole) being unapertured, while the central layer 30 is apertured. The laminate substrate web can be made without requiring registration of the layers to ensure bonding of the outer layers through the apertures of the central layer(s). One way of describing one embodiment of a web 10 as described above, is that the unitary web 10, when viewed orthogonally by the un-aided human eye from a distance of approximately 50 cm, exhibits no apertures or perforations through the entire laminate, but bond sites 50 are nevertheless visible.

The laminate web 10 is further characterized in that the joining of the three plies into a unitary web can be achieved in the absence of adhesive. Thus in some embodiments no adhesive is required to bond the plies together. Joining is achieved by the input of energy into the constituent layers, such as by thermal melt bonding of the two outer layers together at the melt bond sites 50. In other embodiments, the energy input can be via ultrasonic bonding. Accordingly, a laminate web, that is a unitary web, can be formed without the use of adhesives. Not only does this simplify processing and lower the cost of the laminate web, when certain materials such as nonwoven webs are used, it results in a more flexible, softer web.

As shown in FIG. 2, central layer 30 is chosen such that when the constituent web layers of laminate web 10 are processed as aforementioned, portions of central layer 30 in the region of the melt bond sites 50 separate to permit the first outer layer 20 to melt bond directly to the second outer layer 40 at the interface of the two materials 52 at melt bond sites 50. Thus, apertures in the central layer 30 are formed in the lamination step by displacement, just prior to the bonding of the outer layers as detailed by the method of the present invention below. In this manner, central layer 30 can be provided as an unapertured web, avoiding complex registration steps to align apertures in registry with bond sites when laminated. Further, central layer 30 need not be thermally compatible with outer layers 20 and 40. Central layer need not be a thermoplastic material, and need not even have a melting point. It simply needs to be displaceable by the forces exerted by the processing equipment. Therefore, one way of describing the laminate web is to distinguish the central layer as being a material differentiated from the materials of the first or second layers by at least one material property selected from thermal properties, elongation properties, elastic properties, or conductive properties. By “thermal properties” it is meant primarily thermal melt properties, such that the central layer has no melting point, or if it has a melting point, it is typically at least about 10 degrees Centigrade higher, or about 20 degrees Centigrade higher than either outer layer, or about 100 degrees Centigrade higher than either outer layer. By “elongation properties” it is meant that in tension, the material of the central layer exhibits an elongation to break that is at least about 10% less than either outer layer, or about 50% less than either outer layer, or can be more than about 100% less than either outer layer. Thus, the central layer can be extensible, while either outer layer can be highly extensible. By “elastic properties” it is meant that the central layer can be, for example, elastic, while either outer layer can be highly elastic, as defined herein. Or the central layer can be non-elastic, and the outer layers elastic or highly elastic. By “conductive properties” as used herein it is meant electrically conductivity, such that the central layer can have an electrical conductivity that is about 10 times as great as the outer layers or about 100 or more times as great as the outer layers. Conductive properties may be facilitated by the central layer being a metallic foil, or by being a conductive polymer, including a conductive nonwoven web.

Without being bound by theory, it is believed that to accomplish the displacement of central layer 30 to form apertures therein and to bond the outer layers, the thermal point calendaring as described in U.S. Publication No. 2003/0028165 should form thermal bond sites having a narrow width W dimension and a high aspect ratio. For example, FIG. 3 shows the melt area of a single melt bond site 50 having a narrow width dimension W and a high aspect ratio, i.e., the length, L, is much greater than the width, W. The length L should be selected to permit adequate bond area while width W is sufficiently narrow such that the protuberance used to form the bond site (as described below) can cut, shear, displace, or otherwise pierce the central layer 30 at the region of the bond sites by the method described below. Width W can be between about 0.003 inches (0.008 cm) and about 0.020 inches (0.050 cm) or between about 0.005 inches (0.012 cm) and about 0.010 inches (0.025 cm), and may be adjusted depending on the properties of central layer 30.

It is believed that the aspect ratio of melt bond site 50 can be as low as about 3 (i.e., ratio of L/W equals 3/1). It can also be between about 4 and 20. It is believed that the aspect ratio of the melt bond sites 50 is limited only by the corresponding aspect ratio of the point bonding protuberances of the calendaring roller(s), as disclosed in U.S. Publication No. 2003/0028165.

In one embodiment, the longitudinal axis of each bond site, I, which corresponds directionally to the length dimension of bond site 50, is disposed in a regular, repeating pattern oriented generally parallel to the machine direction, MD as shown in FIG. 1. But the longitudinal axis of each bond site may be disposed in a regular, repeating pattern oriented in the cross machine direction, or randomly oriented in a mixture of cross and machine directions. In one non-limiting example, the bond sites 50 can be disposed in a “herringbone” pattern.

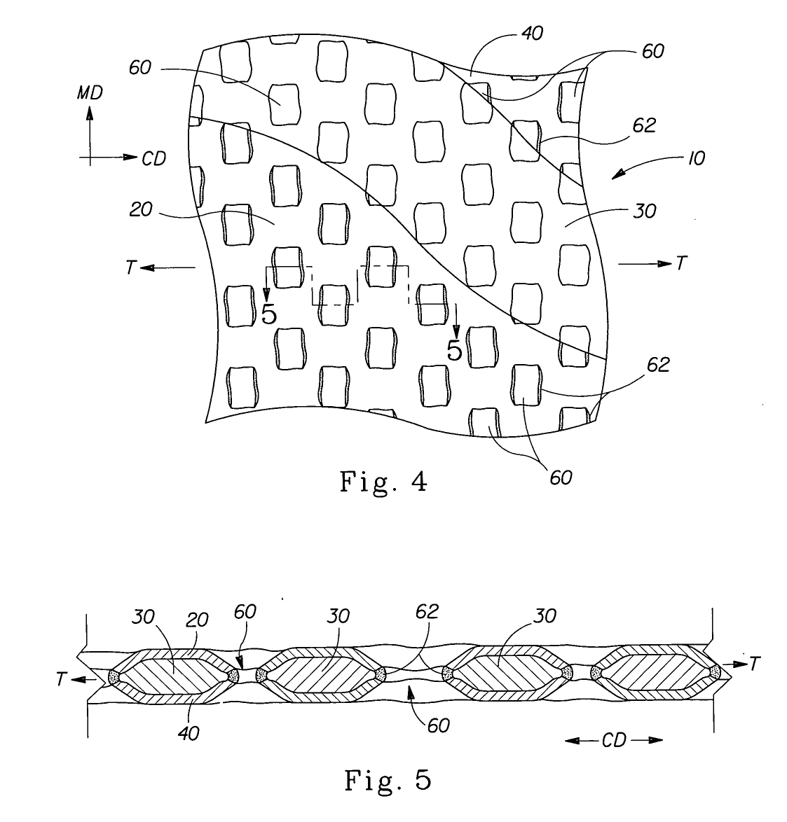

FIG. 4 shows a partially cut-away representation of an apertured laminate. As shown, the partial cut-away permits each layer or ply to be viewed in a plan view. The laminate web 10 shown in FIG. 4 is produced after the thermally bonded laminate is stretched in a direction orthogonal to the longitudinal axis of the melt bond sites, in this case, in the cross-machine direction, CD with sufficient elongation in the direction of extension to cause apertures to form. As shown, where formerly there were melt bond sites 50, apertures 60 are produced as the relatively weak bond sites fail in tension. Also as shown, central layer 30 can remain generally uniformly distributed within laminate 10, depending on the material properties of central layer 30. For example, if central layer 30 is more extensible than outer layers 20 or 40, then it simply extends, either elastically or by plastic deformation, but remains generally uniformly distributed in the unapertured regions of web 10. For example, if a thermoplastic film is utilized as the central layer 30, it extends, either extensibly or elastically (depending on the type of film), but can remain generally uniform, for example, in density or basis weight.

One beneficial property of such a laminate web is that once apertured, fluid communication with the central layer is facilitated. Thus, an absorbent central layer 30 can be used between two relatively non-absorbent outer layers, and the laminate 10 could be an absorptive wiper with a relatively dry to the touch outer surface.

To the extent that central layer 30 is involved, or participates, in any bonding between outer layers 20 and 40, it also participates in the remnant of bonded portions 62, as shown in FIG. 4. The involvement may be due to some degree of actual melt bonding about the perimeter of bond site 50 (e.g., for thermoplastic central layers 30), or it may be due to mechanical interaction, such as by entanglement (e.g., for cellulosic fibrous central layer 30 between fibrous nonwoven layers).

FIG. 5 is a schematic representation of the cross-section denoted in FIG. 4. As shown, apertures 60 form when the laminate web is elongated in the direction T.

An example of one embodiment of a unitary web having a central layer having an elongation to break less than either of the two outer layers, and less than the actual magnitude of extension, is shown partially cut-away in FIG. 5. The partial cut-away permits each layer or ply to be viewed in a plan view. As shown, after extension, central layer 30 becomes fragmented, forming discontinuous regions of the central layer material. These discontinuous regions may be relatively uniformly distributed, such as in rows as shown in FIG. 5, or may be relatively randomly distributed, depending on the pattern of melt bond sites 50, the physical properties of central layer 30, and the method of extension employed.

One example of a web 10 having a structure similar to that shown in FIG. 5 is a web having outer layers of relatively extensible nonwovens, with a central layer of relatively low extensibility tissue paper. Such a laminate would be an apertured laminate web having an absorbent central core, wherein the absorbent core material is in fluid communication with regions exterior to the laminate web. If a relatively hydrophobic nonwoven web is used for the outer layers, such a wipe could exhibit dry-to-the-touch properties along with high absorbency.

One example of a web 10 having a structure similar to that shown in FIG. 5 is a web having outer layers of relatively extensible nonwovens, with a central layer of relatively low extensibility tissue paper. One particularly interesting structure incorporates a highly hydrophobic outer layer combined with a highly absorbent central layer. A suitable hydrophobic material is described in U.S. Pat. No. 3,354,022 Dettre et al. Such a material has a water repellent surface having an intrinsic advancing water contact angle of more than 90 degrees and an intrinsic receding water contact angle of at least 75 degrees. Such a material exhibits highly hydrophobic properties, similar to the effect known to exist on leaves from the Lotus plant. When such a material is combined with an absorbent central layer, one non-limiting example of which is a BOUNTY® paper towel tissue layer, the resulting composite can be highly absorbent while retaining a very clean and dry outer surface. The basis weight and porosity of the outer layer can be varied to achieve different degrees of absorbent performance.

Other webs and methods of making webs suitable for use in the present invention include but are not limited to those described in the following patents the disclosures of which are incorporated herein by reference: U.S. Pat. No. 3,862,472 issued Jan. 28, 1975 to Norton et al.; U.S. Pat. No. 3,905,863, issued Sep. 16, 1975 to Ayers; U.S. Pat. No. 3,974,025 issued Aug. 10, 1976 to Ayers; U.S. Pat. No. 3,918,126 issued Nov. 11, 1975 to Wood; U.S. Pat. No. 3,982,302 issued Sep. 28, 1976 to Vaalburg; U.S. Pat. No. 4,004,323 issued Jan. 25, 1977 to Gotchel et al.; U.S. Pat. No. 4,014,635 issued Mar. 29, 1977 to Kroyer; U.S. Pat. No. 4,057,669 issued Nov. 8, 1977 to McConnell; U.S. Pat. No. 4,064,600 issued Dec. 27, 1977 to Gotchel et al.; U.S. Pat. No. 4,074,393 issued Feb. 21, 1978 to Hicklin et al.; U.S. Pat. No. 4,097,965 issued Jul. 4, 1978 to Gotchel et al.; U.S. Pat. No. 4,130,915 issued Dec. 26, 1978 to Gotchel et al.; U.S. Pat. No. 4,144,619 issued Mar. 20, 1979 to White et al.; U.S. Pat. No. 4,176,426 issued Dec. 4, 1979; U.S. Pat. No. 4,176,427 issued Dec. 4, 1979 to Neuenschwander; U.S. Pat. No. 4,1919,609 issued Mar. 4, 1980 to Trokhan; U.S. Pat. No. 4,207,367 issued Jun. 10, 1980 to Baker, Jr.; U.S. Pat. No. 4,296,161 issued Oct. 20, 1981 to Kaiser et al., U.S. Pat. No. 4,309,469 issued Jan. 5, 1982 to Varona; PCT Publication No. WO 00/08998 published in the name of Hanser et al. on Feb. 24, 2000.

B. Composition

The substrate of the present invention includes a composition comprised of from about 0.01% to about 25% by weight based on the composition, or from about 0.05% to about 15% by weight based on the composition, or from about 0.1% to about 5% by weight based on the composition of an allergen control agent. Suitable allergen control agents include but are not limited to substituted benzoic acids including but not limited to 3,4,5-trihydroxybenzoic acid (also known as gallic acid), and preferably 3,4,5-trimethoxybenzoic acid. Other non-limiting examples of suitable allergen control agents include benzoic acid esters, such as benzyl benzoate.

Other components of the composition which may be added if desired include flocculating polymer, organic solvent, surfactant, soil suspending polymer, perfume, and combinations thereof. When used, these other components may be included in the composition in the following amounts: from about 0.001% to about 0.5% by weight of flocculating polymer, from about 0. 0.05% to about 15% by weight of organic solvent, from about 0.001% to about 10% or from about 0.01% to about 2% by weight of surfactant, from about 0.001% to about 0.5% by weight of soil suspending polymer, and from about 0.001% to about 1% by weight of perfume. Up to about 2% by weight of other optional ingredients may also be included as part of the composition. Non-limiting examples of these other optional ingredients include detersive builders, enzymes, enzyme stabilizers (non-limiting examples of which include propylene glycol, boric acid and/or borax), foam control agents, soil suspending agents, soil release agents, pH adjusting agents, chelating agents, phase stabilizers, solubilizers, brighteners, preservatives, antimicrobial agents, coloring agents, and mixtures thereof.

If desired, the composition may also optionally include microencapsulated actives. One or more active may be contained within a single microencapsulate. Different active-containing microencapsulates may also be used. The composition may be comprised of from about 0.01% to about 10% by weight of the microencapsulated active (i.e.; based on the microcapsule and the active contained therein), or from about 0.025% to about 5% by weight of the microencapsulated active, or from about 0.05% to about 1% by weight of the microencapsulated active. Non-limiting examples of microencapsulated actives include perfume, surfactant, silicone, antimicrobial agents, allergy control agents, emolients, softening agents, conditioning agents, preservatives, and the like. Microencapsulated actives suitable for use in the present invention include but are not limited to those disclosed in U.S. Application Ser. No. 60/685,815 filed on May 31, 2005.

The ratio of the mass of the composition to the mass of the substrate is typically in the range of from about 10:1 to about 1:1 or from about 6:1 to about 3:1.

Without being bound by theory, it is believed that when used the flocculating polymer is irreversibly adsorbed on the cellulosic component of the wipe so as to flocculate the dirt away from the surface being cleaned thereby holding the dirt and contaminants in the interior of the substrate. As the cellulosic layer forms the central ply of the web it is not in direct contact with the fabric being cleaned. This prevents the dirt from being smeared on the fabric. Further, the nonvolatile solvent solubilizes the surface dirt and makes it easier to be removed. Being nonvolatile, the solvent allows sufficient working time before the fabric dries out. This allows the user sufficient time to clean the fabric before the composition dries thereby alleviating excessive reapplication of the composition. This allows for more efficient cleaning with a single wipe.

While not wishing to bound by theory it is believed that it is undesirable to overload the substrate with flocculating polymer as the polymer may have a tendency to be released onto the surface being cleaned thereby allowing for the dirt and contaminants to be flocculated/remain on the fabric being cleaned.

Allergen Control Agent

The composition of the present invention includes an allergen control agent. The allergen control agent comprises from about 0.01% to about 25% by weight of the composition, or from about 0.05% to about 15% by weight of the composition, or from about 0.1% to about 5% by weight of the composition. While not wishing to be limited by theory, it is believed that in addition to the surfactant component of the composition, the allergen control agent exhibits enzymatic activity on allergenic proteins, rendering them less immunogenic.

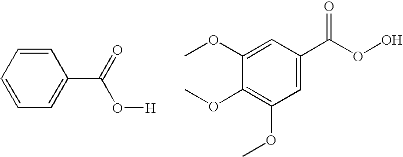

Benzoic Acid 3,4,5-trimethoxybenzoic acid

Allergen control agents may include benzyl derivatives or chemicals that contain benzyl moieties, non-limiting examples of which are shown in Table A below.

TABLE A
NON-LIMITING EXAMPLES OF BENZYL DERIVATIVES

| SUBCATEGORY | EXAMPLES |
|---|---|
| Benzyl Alcohols | Benzyl Alcohol |
| | o-Benzyl-p-Chlorophenol |
| Benzaldehydes | Benzaldehyde |
| | p-Methoxybenzaldehyde |
| | m-Methoxy-p-Hydroxybenzaldehyde |
| Benzyl Esters | Benzyl Acetate |
| | Benzyl Benzoate |
| | Benzyl Salicylate |
| | Benzyl Cinnamate |
| | Benzyl Glutamate |
| | Benzyl Chlorocarbonate |
| | Benzyl Propionate |
| | Benzyl Butyrate |
| Benzyl Acids | Benzoic Acid |
| | Para-Aminobenzoic Acid |
| Benzoate Esters | Methyl Benzoate |
| | Methyl-p-Methylbenzoate |
| 2-Hydroxybenzoate | Methyl 2-Hydroxybenzoate |
| Esters | Pentyl 2-Hydroxybenzoate |
| | Benzyl 2-Hydroxybenzoate |
| Benzyl Halides | Benzyl Chloride |
| | Benzyl Bromide |
| | Benzyl Iodide |
| | N-Alkyl Dimethyl Benzyl Ammonium Chloride |
| | Benzyl Ammonium Chloride |
| Benzyl Amines | N-Benzyl-p-Phenylenediamine |
| | Benzylamine |
| | Di-Benzylamine |
| Benzyl Ethers | Benzyl Ether |
| Other Benzyl Derivatives | Benzyl Isoeugenyl |
| | Benzyl Phthalate |
| | Alkyl Benzyl Ketone |

One suitable allergen control agent is benzoic acid. A preferred benzoic acid useful for allergen control is 3,4,5-trimethoxybenzoic acid. This agent is also known by the following names: trimethylgallic acid, eudesmic acid, tri-o-methylgallic acid, gallic acid trimethyl ether, and 5-methoxy-veratric acid.

The benzyl moiety can be delivered in a number of ways non-limiting examples of which include: as a chemical agent, as a natural extract rich in benzyl derivatives (examples of which include but are not limited to lavender oil, geranium oil, horseradish extracts, eucalyptus extracts, cotton blossom extract, or juniper essences), as a botanical extract obtained through benzyl-mediated extractions or processes (examples of which include but are not limited to benzyl alcohol extraction or acid fractionation with benzoic acid), or combinations thereof.

Some allergen control agents may be crystalline in nature. When using an allergen control agent which is crystalline, a miscibility agent such as an alcohol may be used to render the allergen control agent miscible with the composition. A suitable alcohol for this purpose includes but is not limited to alcohol. A typical ratio of allergen control agent to miscibility agent is from about 1:1, or from about 1:1.5, or from about 1:2.5.

Organic acids and/or their esters may also be optionally included with the allergen control agent of the present invention. Suitable organic acids and/or their esters include but are not limited to: carboxylic acids and their esters, phenolic acids and their esters, polyphenolic acids and their esters, and mixtures thereof. While not wishing to be limited by theory, it is believed that the addition of an organic acid may help enhance the enzymatic activity of the allergen control agents, thereby enhancing the ability of the allergen control agent to denature the proteins which typically comprise the allergen. When used, the optional organic acid is typically added in a range from about 0.1% to about 5% by weight of the composition.

Flocculating Polymer

Compositions and systems of the present invention may comprise from about 0.001%, to about 0.5%, or from about 0.01 to about 0.1% of a flocculating polymer, wherein the polymer comprises at least one cationically charged unit, inter alia, quaternary ammonium moiety or unit which can form a cationic charge in situ, inter alia, an amine moiety. Stated in another way, the oligomer, polymer, or co-polymer resulting from the herein below described monomer units have one net cationic charge at a pH=7. The charge can be distributed among any of the herein described units.

The flocculating polymer adsorbs irreversibly on the non-woven substrate and helps flocculate or trap the dirt on it. This prevents the dirt from being smeared around on the surface that is being cleaned.

Cationic polymers in general and their method of manufacture are known in the literature. For example, a detailed description of cationic polymers can be found in an article by M. Fred Hoover that was published in the Journal of Macromolecular Science-Chemistry, A4(6), pp 1327-1417, October, 1970. The entire disclosure of the Hoover article is incorporated herein by reference. Other suitable cationic polymers are those used as retention aids in the manufacture of paper. They are described in “Pulp and Paper, Chemistry and Chemical Technology Volume III edited by James Casey (1981). The Molecular weight of these polymers is in the range of 2,000,000 daltons.

The flocculating polymers of this invention will be better understood when read in light of the Hoover article and the Casey book, the present disclosure and the Examples herein.

Suitable flocculating polymers include but are not limited to:

1. polyethyleneimine and its derivatives. These are commercially available under the trade name Lupasol ex. BASF AG of Ludwigschaefen, Germany.

2. Polyamidoamine-epichlorohydrin (PAE) Resins which are condensation products of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington Del. under the trade name Kymene or from BASF A.G. under the trade name Luresin.

These polymers are described in Wet Strength resins and their applications edited by L. L. Chan, TAPPI Press (1994).

Linear Polymer Units

3. Synthetic addition polymers of the general structure 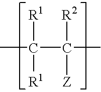
wherein R¹, R², and Z are defined herein below. The linear polymer units are typically formed from linearly polymerizing monomers. Linearly polymerizing monomers are defined herein as monomers which under standard polymerizing conditions result in a linear polymer chain or alternatively which linearly propagate polymerization. The linearly polymerizing monomers of the present invention have the formula: 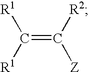
however, those of skill in the art recognize that many useful linear monomer units are introduced indirectly, inter alia, vinyl amine units, vinyl alcohol units, and not by way of linearly polymerizing monomers. For example, vinyl acetate monomers once incorporated into the backbone are hydrolyzed to form vinyl alcohol units. For the purposes of the present invention, linear polymer units may be directly introduced, i.e. via linearly polymerizing units, or indirectly, i.e. via a precursor as in the case of vinyl alcohol cited herein above.

Each R¹ is independently hydrogen, C₁-C₄ alkyl, substituted or unsubstituted phenyl, substituted or unsubstituted benzyl, carbocyclic, heterocyclic, and mixtures thereof. Preferably R¹ is hydrogen, C₁-C₄ alkyl, phenyl, and mixtures thereof, more preferably hydrogen and methyl.

Each R² is independently hydrogen, halogen, C₁-C₄ alkyl, C₁-C₄ alkoxy, substituted or unsubstituted phenyl, substituted or unsubstituted benzyl, carbocyclic, heterocyclic, and mixtures thereof. Preferred R² is hydrogen, C₁-C₄ alkyl, and mixtures thereof.

Each Z is independently hydrogen; hydroxyl; halogen; —(CH₂)ₘR, wherein R is hydrogen, hydroxyl, halogen, nitrilo, —OR³, —O(CH₂)ₙN(R³)₂, —O(CH₂)ₙN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻, a non-aromatic nitrogen heterocycle comprising a quaternary ammonium ion, a non-aromatic nitrogen heterocycle comprising an N-oxide moiety, an aromatic nitrogen containing heterocyclic wherein one or more or the nitrogen atoms is quaternized; an aromatic nitrogen containing heterocycle wherein at least one nitrogen is an N-oxide; —NHCHO (formamide), or mixtures thereof; wherein each R³ is independently hydrogen, C₁-C₈ alkyl, C₂-C₈ hydroxyalkyl, and mixtures thereof; X is a water soluble anion; the index n is from 1 to 6; carbocyclic, heterocyclic, or mixtures thereof; —(CH₂)ₘCOR′ wherein R′ is —OR³, —O(CH₂)ₙN(R³)₂, —O(CH₂)ₙN⁺(R³)₃X⁻, —NR³(CH₂)ₙN(R³)₂, —NR³(CH₂)ₙN⁺(R³)₃X⁻, —(CH₂)ₙN(R³)₂, —(CH₂)ₙN⁺(R³)₃X⁻, or mixtures thereof, wherein R³, X, and n are the same as defined herein above. A preferred Z is —O(CH₂)ₙN⁺(R³)₃X⁻, wherein the index n is 2 to 4. The index m is from 0 to 6, preferably 0 to 2, more preferably 0.

Non-limiting examples of addition polymerizing monomers comprising a heterocyclic Z unit includes 1-vinyl-2-pyrrolidinone, 1-vinylimidazole, 2-vinyl-1,3-dioxolane, 4-vinyl-1-cyclohexene 1,2-epoxide, and 2-vinylpyridine.

The polymers and co-polymers of the present invention comprise Z units which have a cationic charge or which result in a unit which forms a cationic charge in situ. When the co-polymers of the present invention comprise more than one Z unit, for example, Z¹, Z², . . . Zⁿ units, at least about 1% of the monomers which comprise the co-polymers will comprise a cationic unit. Preferred cationic units include —O(CH₂)ₙN⁺(R³)₃X⁻ and —(CH₂)ₙN⁺(R³)₃X⁻. When the co-polymers of the present invention are formed from two monomers, Z¹ and Z², the ratio of Z¹ to Z² is preferably from about 9:1 to about 1:9.

A non-limiting example of a Z unit which can be made to form a cationic charge in situ is the —NHCHO unit, formamide. The formulator can prepare a polymer or co-polymer comprising formamide units some of which are subsequently hydrolyzed to form vinyl amine equivalents. For example the formulator may prepare a co-polymer having the general formula: 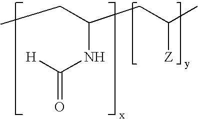
which comprises a formamide unit and then subsequently treat the co-polymer such that some of the formamide units are hydrolyzed to form a co-polymer comprising vinyl amine units, said polymer having the formula: 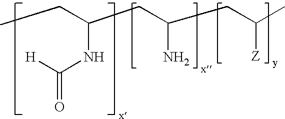
wherein Z may be a cationic unit comprising or non-cationic unit comprising moiety and x′+x″=x.

Another class of preferred linearly polymerizable monomers comprise cationically charged heteroaromatic Z units having the formula: 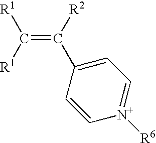
an non-limiting example of which is 4-vinyl (N-alkyl)pyridine wherein R¹ and R² are each hydrogen and R⁶ is methyl.

Another class of preferred linearly polymerizable monomers which comprises a heterocyclic ring includes Z units comprising an N-oxide, for example, the N-oxide having the formula: 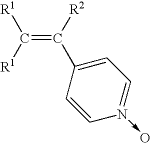
a non-limiting example of which is 4-vinyl pyridine N-oxide.

N-alkyl vinylpyridine monomers and N-oxide vinylpyridine monomers can be suitably combined with other non aromatic monomers, inter alia, vinyl amine. However, preferred polymers of the present invention include co-polymers derived from a combination of quaternized, N-oxide, and nitrogen containing heteroaromatic monomers, non-limiting examples of which includes a copolymer of N-methyl vinyl pyridine and vinyl pyridine in a ratio of 4:1; a copolymer of N-methyl vinyl pyridine and vinyl pyridine in a ratio of 4:6; a co-polymer of poly(N-methyl vinyl pyridine) and vinyl pyridine N-oxide in a ratio of polymer to monomer of 4:1; poly(N-methyl vinyl pyridine) and vinyl pyridine N-oxide in a ratio of polymer to monomer of 4:6; and mixtures thereof.

As described herein above, some preferred polymer residues may be formed by treatment of the resulting polymer. For example, vinyl amine residues are preferably introduced via formamide monomers which are subsequently hydrolyzed to the free amino unit. Also vinyl alcohol units are obtained by hydrolysis of residues formed form vinyl acetate monomers. Likewise, acrylic acid residues may be esterified after polymerization, for example, units having the formula: 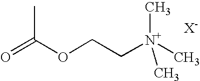
may be more conveniently formed after the backbone has been formed by polymerization with acrylic acid or acrylic acid precursor monomers.

II) Cyclic Units Derived from Cyclically Polymerizing Monomers

The polymers or co-polymers of the present invention can comprise one or more cyclic polymer units which are derived from cyclically polymerizing monomers. Cyclically polymerizing monomers are defined herein as monomers which under standard polymerizing conditions result in a cyclic polymer residue as well as serving to linearly propagate polymerization. Preferred cyclically polymerizing monomers of the present invention have the formula: 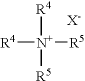
wherein each R⁴ is independently an olefin comprising unit which is capable of propagating polymerization in addition to forming a cyclic residue with an adjacent R⁴ unit; R⁵ is C₁-C₁₂ linear or branched alkyl, benzyl, substituted benzyl, and mixtures thereof; X is a water soluble anion.

Non-limiting examples of R⁴ units include allyl and alkyl substituted allyl units. Preferably the resulting cyclic residue is a six-member ring comprising a quaternary nitrogen atom.

R⁵ is preferably C₁-C₄ alkyl, preferably methyl.

An example of a cyclically polymerizing monomer is dimethyl diallyl ammonium having the formula: 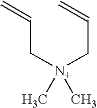
which results in a polymer or co-polymer having units with the formula: 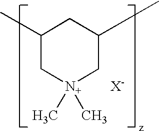
wherein preferably the index z is from about 10 to about 50,000.
III) Mixtures thereof.

The polymers or co-polymers of the present invention retain a net cationic charge, whether the charged is developed in situ, or whether the polymer or co-polymer itself has a formal positive charge. Preferably the polymer or co-polymer has at least 10%, more preferably at least about 25%, more preferably at least about 35%, most preferably at least about 50% of the residues comprise a cationic charge.

The polymers or co-polymers of the present invention can comprise mixtures of linearly and cyclically polymerizing monomers, for example the poly(dimethyldiallyl-ammonium chloride/acrylamide) co-polymer having the formula: 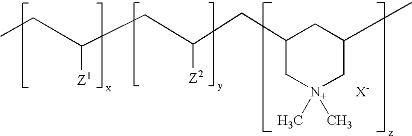
wherein Z¹, Z², x, y, and z are the same as defined herein above and X is a chloride ion.

One embodiment of this invention is the composition comprising a polymer based on dimethyldiallylammonium chloride and a copolymer which is based upon acrylamide with a co-monomer selected from the group consisting of N,N dialkylaminoalkyl(meth)acrylate, N,N dialkylaminoalkylacrylate, N,N dialkylaminoalkylacrylamide, N,N dialkylaminoalkyl(meth)acrylamide, their quaternized derivatives and mixtures thereof.

Non-limiting examples of polymers suitable for use with the present invention include flocculating copolymers comprising:
i) a first monomer selected from the group consisting of N,N dialkylaminoalkyl(meth)acrylate, N,N dialkylaminoalkylacrylate, N,N dialkylaminoalkylacrylamide, N,N dialkylaminoalkyl(meth)acrylamide, their quaternized derivatives, vinylamine or its derivatives, allylamine or its derivatives and mixtures thereof; and
ii) a second monomer selected from the group consisting of acrylic acid, methacrylic acid, C₁-C₆ alkylmethacrylate, C₁-C₆ alkyl acrylate, C₁-C₈ hydroxyalkylacrylate, C₁-C₈ hydroxyalkylmethacrylate, acrylamide, C₁-C₁₆ alkyl acrylamide, C₁-C₁₆ dialkylacrylamide, 2-acrylamido-2-methylpropane sulfonic acid or its alkali salt, methacrylamide, C₁-C₁₆ alkylmethacrylamide, C₁-C₁₆ dialkylmethacrylamide, vinyl formamide, vinylacetamide, vinyl alcohol, C₁-C₈ vinylalkylether, vinyl pyridine, itaconic acid, vinyl acetate, vinyl propionate, vinyl butyrate and mixtures thereof;
   4. Cationic polysaccharides preferably cationic hydroxyethyl cellulose, cationic guar gum and cationic starches. Examples of cationic hydroxyehtyl cellulose is Ucare Polymer JR 25M, Polymer JR 400, Polymer LK 400 and Polymer LR 400 all available from Dow Chemicals Co and Celquat H200 and Celquat L-200 available from National Starch and Chemical Company or Bridgewater, N.J.
   Examples of cationic guar gums are Jaguar C13 and Jaguar Excel available from Rhodia Examples of cationic starches are described by D. B. Solarek in Modified Starches, Properties and Uses published by CRC Press (1986). Cationic starches are commercially available from National Starch and Chemical Company under the Trade Name Cato.

Surfactant

If desired, the compositions herein may comprise from about 0.001% to about 2% by weight of a surfactant or from about 0.01% to about 0.5% by weight of surfactant. Detersive surfactants are preferably, zwitterionic or amphoteric or nonionic type or can comprise compatible mixtures of these types. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980. All of these patents are incorporated herein by reference.

Non-limiting examples of nonionic surfactants include:

a) C₁₂-C₁₈ alkyl ethoxylates, such as, NEODOL® nonionic surfactants from Shell;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronice from BASF;
d) C₁₄-C₂₂ mid-chain branched alcohols, BA, as disclosed in U.S. Pat. No. 6,150,322;
e) C₁₄-C₂₂ mid-chain branched alkyl alkoxylates, BAEX, wherein x 1-30, as disclosed in U.S. Pat. Nos. 6,153,577, 6,020,303, and 6,093,856;
f) alkyl polysaccharides as disclosed in U.S. Pat. No. 4,565,647 issued to Llenado on Jan. 26, 1986; specifically alkylpolyglycosides as disclosed in U.S. Pat. Nos. 4,483,780 and 4,483,779;
   g) Polyhydroxy fatty acid amides as disclosed in U.S. Pat. No. 5,332,528, WO 92/06162, WO 93/19146, WO 93/19038, and WO 94/09099;
   h) ether capped poly(oxyalkylated) alcohol surfactants as disclosed in U.S. Pat. No. 6,482,994 and WO 01/42408.

Preferred surfactants for use herein are the alkylpolysaccharides that are disclosed in U.S. Pat. No. 5,776,872, entitled “Cleansing compositions”, issued Jul. 7, 1998, to Giret et al.; U.S. Pat. No. 5,883,059, entitled “Three in one ultra mild lathering antibacterial liquid personal cleansing composition” issued Mar. 16, 1999, to Furman et al.; U.S. Pat. No. 5,883,062, entitled “Manual dishwashing compositions”, issued Mar. 16, 1999, to Addison et al.; and U.S. Pat. No. 5,906,973, entitled “Process for cleaning vertical or inclined hard surfaces” issued May 25, 1999, to Ouzounis et al.

Suitable alkylpolysaccharides for use herein are disclosed in U.S. Pat. No. 4,565,647, issued to Llenado on Jan. 21, 1986, having a hydrophobic group containing from about 6 to about 30 carbon atoms, preferably from about 10 to about 16 carbon atoms and a polysaccharide, e.g., a polyglycoside, hydrophilic group. For acidic or alkaline cleaning compositions/solutions suitable for use in no-rinse methods, the preferred alkyl polysaccharide preferably comprises a broad distribution of chain lengths, as these provide the best combination of wetting, cleaning, and low residue upon drying. This “broad distribution” is defined by at least about 50% of the chainlength mixture comprising from about 10 carbon atoms to about 16 carbon atoms. Preferably, the alkyl group of the alkyl polysaccharide consists of a mixtures of chainlength, preferably from about 6 to about 18 carbon atoms, more preferably from about 8 to about 16 carbon atoms, and hydrophilic group containing from about one to about 1.5 saccharide, preferably glucoside, groups per molecule. This “broad chainlength distribution” is defined by at least about 50% of the chainlength mixture comprising from about 10 carbon atoms to about 16 carbon atoms. A broad mixture of chain lengths, particularly C₈-C₁₆, is highly desirable relative to narrower range chain length mixtures, and particularly versus lower (i.e., C₈-C₁₀ or C₈-C₁₂) chainlength alkyl polyglucoside mixtures. It is also found that the preferred C₈-16 alkyl polyglucoside provides much improved perfume solubility versus lower and narrower chainlength alkyl polyglucosides, as well as other preferred surfactants, including the C₈-C₁₄ alkyl ethoxylates. Any reducing saccharide containing 5 or 6 carbon atoms can be used, e.g., glucose, galactose and galactosyl moieties can be substituted for the glucosyl moieties. (optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units. The glycosyl is preferably derived from glucose.

Optionally, and less desirably, there can be a polyalkyleneoxide chain joining the hydrophobic moiety and the polysaccharide moiety. The preferred alkyleneoxide is ethylene oxide. Typical hydrophobic groups include alkyl groups, either saturated or unsaturated, branched or unbranched containing from 8 to 18, preferably from 10 to 16, carbon atoms. Preferably, the alkyl group is a straight-chain saturated alkyl group. The alkyl group can contain up to about 3 hydroxyl groups and/or the polyalkyleneoxide chain can contain up to about 10, preferably less than 5, alkyleneoxide moieties. Suitable alkyl polysaccharides are octyl, nonyidecyl, undecyldodecyl, tridecyl, tetradecyl, pentadecyl, hexadecyl, heptadecyl, and octadecyl, di-, tri-, tetra-, penta-, and hexaglucosides and/or galatoses. Suitable mixtures include coconut alkyl, di-, tri-, tetra-, and pentaglucosides and tallow alkyl tetra-, penta- and hexaglucosides.

To prepare these compounds, the alcohol or alkylpolyethoxy alcohol is formed first and then reacted with glucose, or a source of glucose, to form the glucoside (attachment at the 1 position). The additional glycosyl units can then be attached between their 1-position and the preceding glycosyl units 2-, 3-, 4- and/or 6-position, preferably predominantly the 2-position.

In the alkyl polyglycosides, the alkyl moieties can be derived from the usual sources like fats, oils or chemically produced alcohols while their sugar moieties are created from hydrolyzed polysaccharides. Alkyl polyglycosides are the condensation product of fatty alcohol and sugars like glucose with the number of glucose units defining the relative hydrophilicity. As discussed above, the sugar units can additionally be alkoxylated either before or after reaction with the fatty alcohols. Such alkyl polyglycosides are described in detail in WO 86/05199 for example. Technical alkyl polyglycosides are generally not molecularly uniform products, but represent mixtures of alkyl groups and mixtures of monosaccharides and different oligosaccharides. Alkyl polyglycosides (also sometimes referred to as “APGs”) are preferred for the purposes of the invention since they provide additional improvement in surface appearance of the surface being cleaned relative to other surfactants. The glycoside moieties are preferably glucose moieties. The alkyl substituent is preferably a saturated or unsaturated alkyl moiety containing from about 8 to about 18 carbon atoms, preferably from about 8 to about 10 carbon atoms or a mixture of such alkyl moieties. C₈-C₁₆ alkyl polyglucosides are commercially available (e.g., Simusol® surfactants from Seppic Corporation, 75 Quai d'Orsay, 75321 Paris, Cedex 7, France, and Glucopon®425 available from Henkel). In the present invention, the preferred alkyl polyglucosides are those which have been purified enough for use in personal cleansing. Most preferred are “cosmetic grade” alkyl polyglucosides, particularly C₈ to C₁₆ alkyl polyglucosides, such as Plantaren 2000®, Plantaren 2000 NO, and Plantaren 2000 N UP®), available from Henkel Corporation (Posffach 101100, D 40191 Dusseldorf, Germany). Additional suitable nonionic surfactants include polyhydroxy fatty acid amides of the formula:

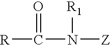

wherein R is a C₉₋₁₇ alkyl or alkenyl, R₁ is a methyl group and Z is glucityl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in U.S. Pat. No. 2,965,576 issued to Wilson and U.S. Pat. No. 2,703,798 issued to Schwartz.

Zwitterionic Surfactants

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 issued to Laughlin et al., granted on Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Ampholytic Surfactants

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Anionic Surfactants

Nonlimiting examples of anionic surfactants useful herein include:
a) C₁₁-C₁₈ alkyl benzene sulfonates (LAS);
b) C₁₀-C₂₀ primary, branched-chain and random alkyl sulfates (AS);
c) C₁₀-C₁₈ secondary (2,3) alkyl sulfates having formulae (I) and (II): 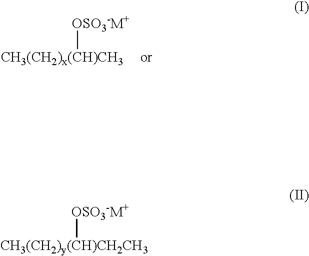
   M in formulae (I) and (II) is hydrogen or a cation which provides charge neutrality. For the purposes of the present invention, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x in formulae (I) and (II) is an integer of at least about 7, preferably at least about 9; y in formulae (I) and (II) is an integer of at least 8, preferably at least about 9;
d) C₁₀-C₁₈ alkyl alkoxy sulfates (AEₓS) wherein preferably x is from 1-30;
e) C₁₀-C₁₈ alkyl alkoxy carboxylates preferably comprising 1-5 ethoxy units;
   f) mid-chain branched alkyl sulfates as disclosed in U.S. Pat. Nos. 6,020,303 and 6,060,443;
g) mid-chain branched alkyl alkoxy sulfates as disclosed in U.S. Pat. Nos. 6,008,181 and 6,020,303;
h) modified alkylbenzene sulfonate (MLAS) as disclosed in: WO 99/05243, WO 99/05242, WO 99/05244, WO 99/05082, WO 99/05084, WO 99/05241, WO 99/07656, WO 00/23549, and WO 00/23548;
i) methyl ester sulfonate (MES); and
j) alpha-olefin sulfonate (AOS)

Cationic Surfactants

Non-limiting examples of anionic surfactants include: the quaternary ammonium surfactants, which can have up to 26 carbon atoms.
a) alkoxylate quaternary ammonium (AQA) surfactants as disclosed in U.S. Pat. No. 6,136,769;
b) dimethyl hydroxyethyl quaternary ammonium as disclosed in U.S. Pat. No. 6,004,922;
c) polyamine cationic surfactants as disclosed in WO 98/35002, WO 98/35003, WO 98/35004, WO 98/35005, and WO 98/35006;
d) cationic ester surfactants as disclosed in U.S. Pat. Nos. 4,228,042, 4,239,660 4,260,529 and 6,022,844; and
e) amino surfactants as disclosed in U.S. Pat. No. 6,221,825 and WO 00/47708, specifically amido propyldimethyl amine.

Semi-Polar Nonionic Surfactants

Non-limiting examples of semi-polar nonionic surfactants include: water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. See WO 01/32816, U.S. Pat. No. 4,681,704, and U.S. Pat. No. 4,133,779.

Organic Solvent

The compositions can also include one or more organic solvents. Suitable organic solvents include but are not limited to alcohols, glycols, glycol ethers, ketones, aldehydes, ethers, alkyl pyrrolidone, and terpenes. The organic solvent may include one or more nonvolatile organic solvents at effective levels, typically from about 0.05% by weight of the composition to about 15% by weight of the composition, or from about 0.1% by weight of the composition to about 10% by weight of the composition, or from about 1% by weight of the composition to about 5%, by weight of the composition.

One non-limiting class of organic solvents which may be used are glycol ethers represented as: 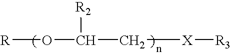
wherein:
R=C₁ to C₈ alkyl, or C₆ to C₈ alkly aryl moiety,
R₂=H or C, to C₄ alkyl
R₃=H or C, to C₆ alkyl, or C₆ to C₈ alkly aryl moiety
X=—O— or C(O)O— group

Examples of glycol ethers are ethyleneglycol methyl ether, ethyleneglycol monoethyl ether, ethyleneglycol monopropyl ether, ethyleneglycol monobutyl, ether, ethyleneglycol monohexyl ether, diethylene glycol methyl ether, diethylene glycol monoethyl ether, diethylene glycol monopropyl ether, diethylene glycol monobutyl ether, diethylene glycol monohexyl ether, triethyleneglycol monomethylether, triethyleneglycol monoethyl ether, triethyleneglycol monobutylether, ethylene glycol phenylether, diethylene glycol phenylether, tri ethylene glycol phenylether, diethylene glycol n-butyl ether acetate, diethylene glycol methyl ether acetate, ethylene glycol methyl ether acetate, ethylene glycol butyl ether acetate, propylene glycol monomethyl ether, diproppylene glycol monomethyl ether, tripropylene glycol monomethyl ether, propylene glycol monoethyl ether, diproppylene glycol monoethyl ether, tripropylene glycol monoethyl ether, propylene glycol monopropyl ether, dipropylene glycol monopropyl ether, tripropylene glycol monopropyl ether, propylene glycol monobutyl ether, diproppylene glycol monobutyl ether, tripropylene glycol monobutyl ether, propylene glycol monohexyl ether, diproppylene glycol monohexyl ether, tripropylene glycol monohexyl ether, propylene glycol phenyl ether, diproppylene glycol phenyl ether, propylene glycol methyl ether acetate, dipropylene glycol methyl ether acetate, ethylene glycol dimethyl ether, diethylene glycol dimethyl ether, triethylene glycol dimethyl ether, tetraethylene glycol dimethyl ether, propylene glycol dimethyl ether, dipropylene glycol dimethyl ether, tripropylene glycol dimethyl ether, polyethylene glycol dimethyl ether, Ethylene glycol dibutyl ether, diethylene glycol dibutyl ether, and polyethylene glycol dibutyl ether.

Nonlimiting examples of glycols are ethylene glycol, propylene glycol, butylene glycol, hexylene glycol, diethylene glycol, dipropylene glycol, polyethylene glycol of molecular weight less than 400, polypropylene glycol of molecular weight less than 400 Nonlimiting examples of alcohols are methanol, ethanol, propyl alcohol, butyl alcohol, pentyl alcohol and hexyl alcohol, benzyl alcohol, cyclohexanol and their derivatives.

Nonlimiting examples of esters are ethyl acetate, propyl acetate, butyl acetate, pentyl acetate, hexyl acetate, methyl propionate, ethyl propionate, butyl propionate, pentyl propionate, ethyl 3-ethoxy propionate (U-CAR ESTER EEP available from Dow Chemicals of Midland, Mich.), glyceryl mono, di and triacetate, glyceryl mono, di and tripropionate, mixed esters of glycerine, methyl, propyl and butyl esters of glycols, preferably ethylene glycol methyl ester, propylene glycol methyl ester.

Nonlimiting examples of terpenes include hydrocarbons and terpene alcohols. These may include limonene, α and β pinene, camphene, fenchene, myrcene, cis-pinane, p-8 menthene, 3-carene, cymene, terpinene, terpinolene, cineole, pinane, cineole, fenchone, linalool, fenchol, citronellal, terpinenol, neomenthol, borneol, isoborneol, menthol, citronellol, neral, and geraniol. Additional examples of terpenes are shown in “Kirk-Othmer Encyclopedia of Chemical Technology Fourth Edition”, Vol. 23, pages 832-882 published by John Wiley and Son of New York City, N.Y.

Other suitable solvents are, pyrrolidone and N-alkyl pyrrolidone such as n-octyl pyrrolidone and n-dodecyl pyrrolidone sold under the trade name SURFADONE LP-100 and SURFADONE LP-300 (available from International Specialty Products of Wayne, N.J.). Preferably, the solvent is soluble in the composition at the level used in the composition. If an insoluble solvent is used, it is solubilized using an appropriate co-solvent or emulsified using an appropriate emulsifier. Preferably, the solvent is non-volatile. The nonvolatile organic solvent has a vapor pressure of less than about 0.1 mm of mercury at about 20° C. or has a boiling point of at least about 230° C. Due to their low volatility, these solvents do not evaporate rapidly and allow sufficient “working” time for the wipe before it dries out. Preferred solvents are esters, alcohols, and glycol ethers.

Such solvents typically have a terminal C₃-C₆ hydrocarbon attached to from about two to about three alkylene glycol moieties to provide the appropriate degree of hydrophobicity, high boiling point (or low vapor pressure) and, preferably, surface activity. Examples of commercially available hydrophobic cleaning solvents based on alkylene glycol chemistry include Triethyleneglycol monomethyl ether (Methoxytriglycol ether from Dow Chemical of Midland, Mich.), Diethylene glycol monoethyl ether (carbitol solvent from Dow Chemical), Triethyleneglylcol monoethyl ether (Ethoxytriglycol from Dow Chemical), diethyleneglycol butylether (Butyl Carbitol), Triethyleneglycol monobutyl ether (Butoxytriglycol ether), Diethyleneglycol monohexyl ether (Hexyl Carbitol), ethylene glycol phenyl ether (DOWANOL EPH), Dipropyleneglycol methyl ether (DOWANOL DPM), Tripropylene glycol methyl ether (DOWANOL TPM), Dipropylene glycol methylether acetate (DOWANOL DPMA), Dipropylene glycol n-propyl ether (DOWANOL DPnP), Tripropyleneglycol n-propyl ether (DOWANOL TPnP), dipropyleneglycol n-butyl ether (DOWANOL DPnB), Tripropylene glycol n-butyl ether (DOWANOL TPnB), Propyleneglycol phenyl ether (DOWANOL PPh). These solvents are commercially available from Dow Chemical of Midland, Mich.

Additional solvents of this class are available from Clariant GmbH of Werk Gendorf, Germany, examples of which include Methyl tetraglycol and buyl polyglycol.

Soil Suspending Polymers

Compositions and systems of the present invention if desired may comprise from about 0.001% to about 0.5% or from about 0.01% to about 0.15% of a soil suspension polymer. The polymer is a water soluble ethoxylated amine having soil removal properties. These compounds are selected from ethoxylated monoamines, ethoxylated diamines, ethoxylated polyamines, ethoxylated amine polymers and mixtures thereof. One preferred soil suspension polymer is polyethyleneimine (“PEI”) 600 ethoxylated (20 mole per nitrogen) available having a minimum molecular weight of about 9,000 daltons. The soil suspending polymer enhances the cleaning efficacy of the composition by suspending particulate soils such that they can be more easily removed by the substrate.

Method of Treating Household Fabric-Based Materials with the Moistened Disposable Wipe Article of the Present Invention

The present invention also includes a method for treating the household fabric-based materials with the premoistended disposable wipe of the present invention. This includes contacting the wipe to the surface to be cleaned, applying the composition to the surface to be cleaned, and transferring the dirt and contaminants from the surface to be cleaned to the wipe. In one non-limiting embodiment, a user sprays the wipe with the composition prior to contacting the surface to be cleaned with the wipe. In yet another non-limiting embodiment, a user sprays the surface to be cleaned with the composition prior to contact by the wipe. In another non-limiting embodiment, the composition is applied to the wipe during manufacture and provided to the user in a premoistened form. In a further non-limiting embodiment, the composition is applied to the wipe during manufacture. The user then moistens the wipe at the time of use.

Kit

The disposable wipe of the present invention may be provided alone or it may also optionally be provided in conjunction with an implement as a kit for cleaning household surfaces such as fabric-based materials around the house. In use, a user will typically attach the moistened disposable wipe to the implement to facilitate cleaning. Non-limiting implements which may be used in conjunction with the present invention include but are not limited to those disclosed in U.S. patent application Ser. No. 11/401,810 filed on Apr. 11, 2006; U.S. Pat. No. Publication No. 2005/0060827 published Mar. 25, 2005; U.S. Publication No. 2006/0048318 published Mar. 9, 2006; U.S. Pat. No. 6,484,346 issued to Kingry et al. on Nov. 26, 2002, U.S. Pat. No. 6,305,046 issued to Kingry et al. on Oct. 23, 2001; U.S. Pat. No. 6,669,391 issued to Policicchio et al. on Dec. 20, 2003; and U.S. Publication No. 2002/005001 published in the name of Willman et al. on May 2, 2002. Other implements which may be used in conjunction with the moistened wipe of the present invention include but are not limited to CLOROX READY MOP, SCOTCH BRITE TUB AND TILE SCRUBBER, and SCOTCH BRITE BATHROOM FLOOR CLEANER.

The disposable wipe of the present invention may be overwrapped. Non-limiting examples of suitable overwraps include shrink wrap, foil, or the like (not shown). The wipes may be provided in a package (not shown) such as a box, pouch, or carton. The box, pouch, or carton may optionally include a sample of the wipe so as to allow the user to touch, view, and/or smell the wipe, prior to purchase. The overwrap, box/carton/pouch, or a combination thereof may include an opening or window so as to allow the user to view and/or touch at least some portion of the wipe and/or optionally the implement if included.

Use Identifiers

Use identifiers (not shown), may be used if desired in order to identify what the disposable wipe and/or optional cleaning implement may be used for. In addition to or alternatively, one or more use identifiers can also be utilized for example to indicate the types and/or forms of surfaces the disposable wipe and/or optional cleaning implement may be used on. The use identifier may be utilized to quickly and easily communicate to a user what type of surfaces the disposable wipe and/or optional cleaning implement may be used on. Use identifiers could be included if desired on one or more of the following: on the packaging for the kit, the cleaning implement, the disposable wipe, or a combination thereof; on the cleaning implement itself; on the disposable wipe itself; on the disposable wipe(s) and/or cleaning implement overwrap; on a label attached for instance to some part of the kit including but not limited to: the package, the cleaning implement, the disposable wipe, the disposable wipe overwrap, or combinations thereof; on the use instructions; on separate print advertising; on in-store displays or the like; or combinations thereof. Non-limiting examples of the form of the use identifier could be in the form of written words, pictorials, graphics, symbols/icons, and the like, as well as combinations thereof. Non-limiting examples would be a use identifier which combines an icon and one or more words to indicate for example that the disposable wipe and/or optional cleaning implement could be used on fabric. Additional non-limiting examples include combining an icon and one or more words to indicate that the disposable wipe and/or optional cleaning implement could be used on: upholstery; draperies; pillows; comforters; bedding including but not limited to bed linens and mattress covers; car fabrics; baby/infant fabric items including but not limited to strollers and car seats, or the like; clothing; fabric clothing accessories including but not limited to purses, wallets, and shoes; or combinations thereof. For instance, one non-limiting use identifier could comprise the combination of an icon of a car with the words “car fabrics”. Another non-limiting use identifier could comprise the combination of an icon of a sofa with the word “upholstery”. Another non-limiting use identifier could comprise an icon of a stroller with the words “baby items”. Yet another non-limiting use identifier could comprise an icon of a bed with the words “bedding”.

Self-Instructing Article of Commerce

The present invention also encompasses an article of commerce comprising the disposable wipe described above. The article of commerce may also comprise a kit which includes the disposable wipe in conjunction with the cleaning implement described above. A set of instructions may be included in association with the article of commerce which directs the user to follow the method of cleaning surfaces around the house with the disposable wipe or the disposable wipe and cleaning implement. For instance, in one non-limiting embodiment, such instructions may direct the user to attach a disposable wipe to the implement and contact the area(s)/surface to be cleaned with the cleaning article. In another non-limiting embodiment, such instructions may direct the user to contact a surface to be cleaned using the disposable wipe without the implement. In yet another non-limiting embodiment, the user may be directed to remove a disposable wipe from whatever the wipe is packaged in such as an overwrap, box, carton, pouch, or the like, attach the wipe to the implement, and to contact the area(s)/surfaces to be cleaned with the wipe.

Herein, “in association with”, when referring to such instructions, means the instructions are either directly printed on the implement; directly printed on the packaging for the implement and/or the cleaning sheet; printed on a label attached to the packaging for the implement and/or the cleaning sheet; or presented in a different manner including, but not limited to, a brochure, print advertisement, electronic advertisement, broadcast or internet advertisements; and/or other media, so as to communicate the set of instructions to a consumer of the implement and/or the cleaning sheet.

Methods

Method for Determining Capacity

Capacity may be measured using the following technique which is adapted from EDANA 10.1. A 2 inch×6 inch (5 cm×15 cm) sample of the substrate is cut, weighed and immersed in distilled water for 3 minutes. The sample is then removed and allowed to drip for 10 seconds and reweighed. The absorption capacity of the substrate reported in grams of liquid absorbed in the substrate per gram of substrate is calculated by the following equation:
(wet weight of substrate−dry weight of substrate)/dry weight of substrate

Method for Determining Fuzz Level

This method can be used as a quantitative prediction of the level of fuzz associated with nonwoven or laminate materials. The fuzz level may be determined in accordance with the Fuzz Level Test disclosed in U.S. Publication No. 2002/0119720.

Method for Determining Caliper

Caliper is measured in accordance with EDANA (European Disposables and Nonwovens Association) Method 30.5-99 using a caliper foot pressure of 0.5 kPa. An instrument suitable for this purpose is the ProGage thickness tester available from Thwing-Albert Instrument Company of Philadelphia, Pa.

Method for Determining Stiffness

Stiffness of a dry substrate is measured in accordance with ASTM D5650-97 entitled “Standard Test Method for Resistance to Bending of Paper of Low Bending Stiffness (Taber-Type Tester in 0-10 Taber Stiffness Unit Configuration)”. A suitable instrument for measuring stiffness per this method is a V-5 Teledyne Taber Stiffness Tester (model 150-B) available from Teledyne Taber Instruments of North Tonawanda, N.Y. If it is desired to determine the stiffness of a wet substrate, ASTM D5650-97 is modified by immersing each sample of substrate to be tested in distilled water for 3 minutes. The sample is then removed and allowed to drip for 10 seconds. Stiffness is then measured in accordance with ASTM D5650-97.

Method for Determining the Average Aperture Size and the % Open Area of the Substrate

The following method can be used for determining the average size i.e., area of the aperture in a substrate and the % open area of the substrate.

Apparatus:

HP Scanjet TMA 3970 scanner (or equivalent scanner with 2200 dpi resolution) available from Hewlett-Packard Company Palo Alto, Calif. 94304 (650) 857-1501

Certified millimeter ruler (0.1 mm divisions)

Black cardboard paper

Image Pro Plus Software 4.0 or better avaiable from Media Cybernetics, Inc. Silver Spring, Md. 20910 (301)-495-3305

Computer

Printer

Sample Preparation:

Cut cardboard frames made 4.75 inches×4.75 inches (12 cm×12 cm) on the outside with inside of the frames cut out, leaving a 1 inch (2.54 cm) cardboard perimeter. Cover the frame with double-sided tape (1 inch wide) (2.54 cm) and place the frame on a wound roll, sticky side down, centering it over the area to be measured. With the material attached, cut around the frame to remove it from the roll.

Data Collection—Collecting the Image:

Lay the ruler on the scanner with the millimeter side face down, then lay the framed sample over the ruler on the scanner and finally lay the black cardboard paper on top of the sample. Scan the image into the scanner per the scanner instruction making sure the resolution is set to ≧200 dpi and then use the zoom to adjust the area of interest. Save the image as a high resolution bitmap or other uncompressed image form.

Data Analysis Using Image Pro Software

Open and import the image into the Image Pro software per the instructions with the program. Calibrate the spacing of the picture using the image and ruler to set a pixel/mm value. Select the area of interest in the image and convert it to a greyscale. Adjust the grey scale ranges on the count sizes to highlight all the apertures after setting the software to aperture size and % open area. Note for aperture size do not include partial apertures that are on the edge of the sample or picture area that do not represent full apertures, while for the % open area these apertures should be included. The software will then calculate the average aperture size area and % open area.

### EXAMPLES

Examples of Wipe Substrates

Non-limiting examples of substrates which may be used for the moistened wipe of the present invention are disclosed below.

In one non-limiting embodiment of a substrate made in accordance with the present invention (shown as Test Substrate 1 in Table I below), a four layer apertured laminate composite is formed from nonwoven webs. The four layer composite is comprised of 2 outer layers which are polypropylene (“PP”) carded nonwoven each of which has a basis weight of approximately 31 g/m² (commercially available from BBA Nonwovens of Simpsonville, S.C. under code number FPN336) and two inner layers which are wetlaid cellulose each of which has a basis weight of approximately 23 g/m² (commercially available from Cellu Tissue Corporation of East Hartford, Conn. under code number 7020 HWS). This four layer composite after aperturing has a basis weight of approximately 91 g/m² and is commercially available from Precision Fabrics Group (“PFG”) of Greensboro, N.C. under style No. 36385000110000.

Another non-limiting embodiment of a laminate substrate made in accordance with the present invention (shown as Test Substrate 2 in Table I below), is a four layer apertured laminate composite formed from nonwoven webs. The four layer composite is comprised of 2 outer layers, with each being a blend of 40% 2 denier polypropylene fiber, 40% 6 denier polypropylene fiber, and 20% rayon fiber provided as a homogonously carded nonwoven. Each outer layer has a basis weight of approximately 50 g/m² (commercially available from BBA Nonwovens of Simpsonville, S.C. under grade number BD0216). The two inner layers are each comprised of wetlaid cellulose each of which has a basis weight of approximately 23 g/m² (commercially available from Cellu Tissue Corporation of East Hartford, Conn. under code number 7020 HWS). This four layer composite, after aperturing, has a basis weight of approximately 127 g/m².

TABLE I

| | | | | | | Avg. | |
|---|---|---|---|---|---|---|---|
| | Approx. | Approx. | Approx. | CD* Dry | CD* Wet | Aperture | Open |
| Material | Capacity | Fuzz | Caliper | Stiffness | Stiffness | Area | Area |
| (g/g) | (mg/cm²) | (mg/cm²) | (mm) | (g-cm) | (g-cm) | (mm²) | (%) |
| Test Substrate 1: | 4.4 | 0.09 | 1.11 | 1.38 | 0.47 | 0.76 | 6.9 |
| PFG 97 g/m² PP/ | | | | | | | |
| cellulose composite | | | | | | | |
| (Style 3638 50001 | | | | | | | |
| 10000) | | | | | | | |
| Test Substrate 2: | 6.5 | 0.28 | 1.18 | 2.80 | 2.40 | 0.46 | 6.9 |
| Laminate 37-2 | | | | | | | |

*CD refers to the cross direction of the substrate sample.

In another non-limiting alternate embodiment of a four layer apertured laminate substrate (not shown in Table 1), the substrate is comprised of 2 outer layers which are polypropylene (“PP”) carded nonwoven (commercially available from BBA Nonwovens of Simpsonville, S.C. under code number FPN336) and two inner layers of cellulose each of which is comprised of BOUNTY® towel (commercially available from the instant assignee).

Non-Limiting Examples of Liquid Cleaning Solutions Useful for the Wipes of the Present Invention

| | Example 1 | Example 2 | Example 3 | Example 4 |
|---|---|---|---|---|
| | Wt % | Wt % | Wt % | Wt % |
| C10 Alkylpolyglucoside¹ | 0.05 | 0.05 | 0.05 | 0.05 |
| (SURFACTANT) | | | | |
| Polyethyleneimine² | 0.02 | 0.02 | 0.02 | 0.02 |
| Triethylene glycol monomethyl ether³ | 1.0 | — | — | — |
| Diethylene glycol monoethyl ether³ | — | 1.0 | — | — |
| Octyl pyrrolidone⁴ | — | — | 1.0 | |
| Butyl polyglycol⁵ | — | — | — | 1.0 |
| Polyethyleneimine 600 ethoxylated (20 mol) | 0.15 | 0.15 | 0.15 | 0.15 |
| per nitrogen¹⁰ | | | | |
| Ethoxylated castor oil¹¹ | 0.01 | 0.01 | 0.01 | 0.01 |
| Diethylenetriamine pentaacetic acid¹² | 0.4 | 0.4 | 0.4 | 0.4 |
| 3,4,5-trimethoxybenzoic acid₁₃ | 0.2 | 0.2 | 0.2 | 0.2 |
| Benzyl alcohol₁₄ | 0.5 | 0.5 | 0.5 | 0.5 |
| Perfume | 0.0075 | 0.0075 | 0.0075 | 0.0075 |
| Water | To 100% | To 100% | To 100% | To 100% |
| | Example 5 | Example 6 | Example 7 | Example 8 |
| | Wt % | Wt % | Wt % | Wt % |
| C10 Alkylpolyglucoside¹ | 0.05 | 0.05 | 0.05 | 0.05 |
| Polyvinyl formamide co-vinylamine⁶ | 0.02 | — | — | — |
| Polydimethyldiallylammoniumchloride⁷ | — | 0.02 | | — |
| Cationic guar gum⁸ | — | — | 0.02 | — |
| Setleze 3000⁹ | — | — | — | 0.02 |
| Triethylene glycol monomethyl ether³ | 1.0 | 1.0 | 1.0 | 1.0 |
| Polyethyleneimine 600 ethoxylated (20 mol) | 0.15 | 0.15 | 0.15 | 0.15 |
| per nitrogen¹⁰ | | | | |
| Ethoxylated castor oil¹¹ | 0.01 | 0.01 | 0.01 | 0.01 |
| Diethylenetriamine pentaacetic acid¹² | 0.4 | 0.4 | 0.4 | 0.4 |
| 3,4,5-trimethoxybenzoic acid¹³ | 0.2 | 0.2 | 0.2 | 0.2 |
| Benzyl alcohol¹⁴ | 0.5 | 0.5 | 0.5 | 0.5 |
| Perfume | 0.0075 | 0.0075 | 0.0075 | 0.0075 |
| Suds suppressors, preservative and | 0.1 | 0.1 | 0.1 | 0.1 |
| other minor ingredients | | | | |
| Water | To 100% | To 100% | To 100% | To 100% |

¹Surfactant available from Cognis Corp of Cincinnati, OH under the trade name Plantaren.
²Cationic flocculating polymer available from BASF AG, under the trade name Lupasol SK having a molecular weight of 2,000,000 daltons.
³Non-volatile solvent available from Dow Chemicals, Midland MI
⁴Non-volatile solvent available from International Specialty Products, Wayne, NJ
⁵Non-volatile solvent available from Clariant GmbH of Gendorf, Germany
⁶Cationic flocculating polymer available from BASF AG having a molecular weight of 25,000 daltons.
⁷Cationic flocculating polymers available from Calgon Corporation under the trade name Merquat 100 having a molecular weight of 10,000 daltons.
⁸Cationic floccutating polymer available from Aqualon Company of Wilmington, Delaware under the tradename N-Hance 3000 having a molecular weight of 1,000,000 daltons.
⁹Copolymer of vinyl pyrrolidone and dimethyaminoethylmethacrylamide available from International Specialty Products of Wayne, New Jersey.
¹⁰Soil Suspension Plymer having a minimum molecular weight of 9,000 daltons, available from Nippon Shokubai Co., Ltd., of Osaka, Japan.
¹¹Solubilizer available from LCW of South Plainfeild, New Jersey.
¹²Chelating agent available from BASF of Mount Olive, New Jersey.
¹³Allergen Control Agent: TMBA (3,4,5 trimethoxybenzoic acid), available from Spectrum Chemicals, New Brunswick, New Jersey.
¹⁴Solvent for allergen control agent: Benzyl alcohol, supplied by Mallinckrodt Baker, Phillipsburg, New Jersey.

The liquid composition may be prepared by premixing the benzoic acid with benzyl alcohol. The remainder of the ingredients, excluding water and perfume (if used), are mixed together to homogeneity. The allergen control premix is added to this mixture and the pH of this mixture is adjusted to approximately 6.5 to 7.5. The soil suspending agent is then added to this mixture. The benzoic acid/alcohol premix is added to this mixture. If used, the perfume is then added to the mixture. The pH is then adjusted to approximately 5. The liquid composition may then be applied to the laminate substrate at approximately a loading level of between about 3 grams of liquid composition/gram of dry substrate to about 4 grams of liquid composition/gram of dry substrate.

### Example 9

An apertured laminate substrate PFG-97 gsm PP/cellulose composite (Style 3638 50001 010000) is moistened with the liquid cleaning solution from Example 1. The liquid is thoroughly distributed to achieve a loading level of approximately 3 grams of liquid composition/gram of dry substrate to about 4 grams of liquid composition/gram of dry substrate.

### Example 10

An apertured laminate substrate PFG-97 gsm PP/cellulose composite (Style 3638 50001 010000) is moistened with the liquid cleaning solution from Example 2. The liquid is thoroughly distributed to achieve a loading level of approximately 3 grams of liquid composition/gram of dry substrate to about 4 grams of liquid composition/gram of dry substrate.

### Example 11

An apertured laminate substrate PFG-97 gsm PP/cellulose composite (Style 3638 50001 010000) is moistened with the liquid cleaning solution from Example 3. The liquid is thoroughly distributed to achieve a loading level of approximately 3 grams of liquid composition/gram of dry substrate to about 4 grams of liquid composition/gram of dry substrate.

### Example 12

An apertured laminate substrate PFG-97 gsm PP/cellulose composite (Style 3638 50001 010000) is moistened with the liquid cleaning solution from Example 4. The liquid is thoroughly distributed to achieve a loading level of approximately 3 grams of liquid composition/gram of dry substrate to about 4 grams of liquid composition/gram of dry substrate.

### Example 13

An apertured laminate substrate PFG-97 gsm PP/cellulose composite (Style 3638 50001 010000) is moistened with the liquid cleaning solution from Example 5. The liquid is thoroughly distributed to achieve a loading level of approximately 3 grams of liquid composition/gram of dry substrate to about 4 grams of liquid composition/gram of dry substrate.

### Example 14

An apertured laminate substrate PFG-97 gsm PP/cellulose composite (Style 3638 50001 010000) is moistened with the liquid cleaning solution from Example 6. The liquid is thoroughly distributed to achieve a loading level of approximately 3 grams of liquid composition/gram of dry substrate to about 4 grams of liquid composition/gram of dry substrate.

### Example 15

An apertured laminate substrate PFG-97 gsm PP/cellulose composite (Style 3638 50001 010000) is moistened with the liquid cleaning solution from Example 7. The liquid is thoroughly distributed to achieve a loading level of approximately 3 grams of liquid composition/gram of dry substrate to about 4 grams of liquid composition/gram of dry substrate.

### Example 16

An apertured laminate substrate PFG-97 gsm PP/cellulose composite (Style 3638 50001 010000) is moistened with the liquid cleaning solution from Example 8. The liquid is thoroughly distributed to achieve a loading level of approximately 3 grams of liquid composition/gram of dry substrate to about 4 grams of liquid composition/gram of dry substrate.

### Example 17

An apertured laminate substrate referred to as laminate 37-2 is moistened with the liquid cleaning solution from Example 1. The liquid is thoroughly distributed to achieve a loading level of approximately 3 grams of liquid composition/gram of dry substrate to about 4 grams of liquid composition/gram of dry substrate.

### Example 18

A spunlaced substrate (Nubtex, 64 grams/sqm comprised of 70% rayon 30% polyester available from BBA Nonwovens, Simpsonville S.C.) may be moistened with the liquid cleaning solution from any of Examples 1-8. The liquid should be thoroughly distributed to achieve the loading of 3.0 g of liquid per gram of dry substrate.

### Example 19

An air-laid substrate Visorb X622 (basis weight 100 g/sqm, 84% NSK Pulp, 14% bicomponent, Buckeye Technologies, Memphis Term.) may be moistened with the liquid cleaning solution from any of Examples 1-8. The liquid should be thoroughly distributed to achieve the loading of 3.0 g of liquid per gram of dry substrate.

The liquid cleaning solution may be applied to the substrate via spraying, roll coating, extrusion, dipping, brushing, and any other ways that would be known to those of ordinary skill in the art. If desired, the wipe may be folded prior to packaging via folding boards or other mechanical manipulation that would be known to those of ordinary skill in the art. Non-limiting examples of equipment systems for applying cleaning solutions to wipes and folding the wipes are available from Paper Converting Machine Company of Green Bay, Wis. (soon to be Barry-Wehmiller Companies, Inc.) which are commercially available under the Viper, Mermaid, Neptune or Calypso trade name.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited herein are in relevant part, incorporated by reference. The citation of any document is not to be construed as an admission that it is prior art with respect to the present invention.

What is claimed is:

1. A disposable wipe for cleaning household surfaces, said disposable wipe comprising:
a) a substrate which is comprised of at least one ply which includes a composition applied to said substrate wherein said composition is applied to said substrate in the amount of from about 0.5 grams of said composition/gram of said substrate by weight to about 8 grams of said composition/gram of said substrate by weight and wherein said composition comprises:
i) an allergen control agent; and
ii) an organic solvent.

2. The disposable wipe of claim 1 wherein said allergen control agent comprises a benzyl derivative, a benzyl moiety, or a combination thereof.

3. A moistened disposable wipe for cleaning household surfaces, said moistened disposable wipe comprising:
a) a substrate which is comprised of at least one ply which includes a composition applied to said substrate wherein said composition is applied to said substrate in the amount of from about 0.5 grams of said composition/gram of said substrate by weight to about 8 grams of said composition/gram of said substrate by weight and wherein said composition comprises:
i) from about 0.01% to about 25% by weight of an allergen control agent;
ii) from about 0.05% to about 15% by weight of an organic solvent; and
iii) balance water and other optional components.

4. A disposable wipe for cleaning household surfaces, said disposable wipe comprising:
a) a layered laminate substrate; and
b) a composition comprising:
i) from about 0.01% to about 25% by weight of an allergen control agent;
ii) from about 0.05% to about 15% by weight of an organic solvent; and
iii) balance water.

5. The disposable wipe of claim 4 wherein said optional components include a flocculating polymer comprising from about 0.001% to about 0.5% by weight of said composition.

6. The disposable wipe of claim 4 wherein said optional components include a soil suspending polymer comprising from about 0.001% to about 0.5% by weight of said composition.

7. The disposable wipe of claim 4 wherein said optional components include a surfactant comprising from about 0.001% to about 2% by weight of said composition.

8. The disposable wipe of claim 4 wherein said composition further comprises a miscibility agent wherein the ratio of said allergen control agent to said miscibility agent is about 1:1.

9. The disposable wipe of claim 4 wherein said optional components include an organic acid comprising from about 0.1% to about 5% by weight of said composition and wherein said organic acid is carboxylic acid, phenolic acid, or a combination thereof.

10. The disposable wipe of claim 4 wherein said allergen control agent comprises a benzyl derivative, a benzyl moiety, or a combination thereof.

11. The disposable wipe of claim 4 wherein said allergen control agent is benzyl alcohol, benzaldehyde, benzyl ester, benzyl acid, benzoate ester, 2-hydroxybenzoate ester, benzyl halide, benzyl amine, benzyl ether, benzyl isoeugenyl, benzyl phthalate, alkyl benzyl ketone, or a combination thereof.

12. The premoistened disposable wipe of claim 4 wherein said allergen control agent is benzoic acid.

13. The premoistened disposable wipe of claim 12 wherein said allergen control agent is 3,4,5-trimethoxybenzoic acid, 3,4,5-trihydroxybenzoic acid, or a combination thereof.

14. A method for cleaning household surfaces, said method comprising the steps of:
a) providing a disposable wipe wherein said disposable wipe comprises:
a substrate which is comprised of at least one ply which includes a composition applied to said substrate wherein said composition is applied to said substrate in the amount of from about 0.5 grams of said composition/gram of said substrate by weight to about 8 grams of said composition/gram of said substrate by weight and wherein said composition comprises:
i) from about 0.01% to about 25% by weight of an allergen control agent;
ii) from about 0.05% to about 15% by weight of an organic solvent; and
iii) balance water and other optional components;
b) contacting said surface to be cleaned with said disposable wipe;
c) applying said composition to said surface; and
d) transferring dirt and contaminants from said surface to said disposable wipe.

15. A method for cleaning household surfaces, said method comprising the steps of:
a) providing a disposable wipe wherein said disposable wipe comprises:
a substrate which is comprised of at least one ply which includes a composition applied to said substrate wherein said composition is applied to said substrate in the amount of from about 0.5 grams of said composition/gram of said substrate by weight to about 8 grams of said composition/gram of said substrate by weight and wherein said composition comprises:
i) from about 0.01% to about 25% by weight of an allergen control agent;
ii) from about 0.05% to about 15% by weight of an organic solvent; and
iii) balance water wherein said water is applied to said substrate by a user;
b) contacting said surface to be cleaned with said disposable wipe;
c) applying said composition to said surface; and
d) transferring dirt and contaminants from said surface to said disposable wipe.

16. The method of claim 14 wherein said optional components include a flocculating polymer which comprises from about 0.001% to about 0.5% by weight of said composition.

17. A disposable wipe for cleaning household surfaces, said disposable wipe comprising:
a) a layered laminate substrate; and
b) a composition comprising:
i) from about 0.01% to about 25% by weight of an allergen control agent;
ii) from about 0.05% to about 15% by weight of an organic solvent;
iii) from about 0.001% to about 0.5% by weight of a flocculating polymer;
iv) from about from about 0.001% to about 0.5% by weight of a soil suspending polymer;
v) from about 0.001% to about 2% by weight of a detersive surfactant; and
vi) balance water and other optional components.

18. The disposable wipe of claim 17 wherein said allergen control agent comprises a benzyl derivative, a benzyl moiety, or a combination thereof.

19. The disposable wipe of claim 17 wherein said allergen control agent is benzyl alcohol, benzaldehyde, benzyl ester, benzyl acid, benzoate ester, 2-hydroxybenzoate ester, benzyl halide, benzyl amine, benzyl ether, benzyl isoeugenyl, benzyl phthalate, alkyl benzyl ketone, or a combination thereof.

20. A kit for cleaning household surfaces, said kit comprising:
a) a moistened disposable wipe comprising a substrate which is comprised of at least one ply which includes a composition applied to said substrate wherein said composition is applied to said substrate in the amount of from about 0.5 grams of said composition/gram of said substrate by weight to about 8 grams of said composition/gram of said substrate by weight and wherein said composition comprises:
i) from about 0.01% to about 25% by weight of an allergen control agent;
ii) from about 0.0.01% to about 15% by weight of an organic solvent;
iii) balance water; and
b) an implement to which said moistened disposable wipe is attached for facilitating contact of said moistened disposable wipe to said household surface.
